(19) United States
(12) Patent Application Publication
(10) Pub. No.: US 2007/0110671 A1
(43) Pub. Date: May 17, 2007

(54) Sensitivity enhancement of POCT devices using gold and silver nanoparticles on patterned substrates

(76) Inventors: Danielle Chamberlin, Belmont, CA (US); Daniel Roitman, Menlo Park, CA (US); Jennifer Qing Lu, Milpitas, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/274,549

(22) Filed: Nov. 14, 2005

(51) Int. Cl. B32B 5/16

(52) U.S. Cl. 424/9.6; 428/323

(57) ABSTRACT

The present invention relates to a substrate including a nanoparticle lattice having uniform interparticle spacing. A system includes a nanoparticle lattice including a ordered pattern of individual nanoparticles, wherein the lattice nanoparticles are assembled by affinity binding.

### BACKGROUND

Noble metal nanoparticles are good at scattering and absorbing light. For example, gold nanoparticles may have a visible color based at least partially upon their size. A solution of 20 nm gold nanoparticles appears red, while larger nanoparticles, for example 60 nm gold nanoparticles appear blue. Metal nanoparticles have been increasingly used as components in chemical sensors. They are well suited to chemical sensing applications because their physical properties often depend sensitively on the chemical environment of the particle.

While metal nanoparticles are used frequently used as labels in affinity-based sensing applications, it is well recognized in the art that traditional applications using gold nanoparticles suffer from lack of sensitivity (poor detection) due to low signal to noise ratios. As such, there is a need in the art to develop an effective way to substantially improve signal to noise ratios for detection of gold and other nanoparticle labels in point of care test, or POCT and arrays.

### SUMMARY

The invention is directed to a system including at least one nanoparticle lattice. The nanoparticle lattice can be located in region of an array or otherwise supported by a substrate. A nanoparticle lattice has uniform interparticle spacing. The distance between any two adjacent nanoparticles in the ordered pattern has a value in a range from 0.5 times to about 10 times the nanoparticle diameter.

The invention is also directed to a kit for use in point of care testing of a sample, the kit including a substrate having at least one nanoparticle lattice. The nanoparticle lattice includes metal nanoparticles arranged in an ordered pattern. Each nanoparticle is operatively connected with one or more immobilized molecules which associate with an analyte when contacted with the sample.

The invention is also directed to a method of detecting or identifying an analyte in a sample. The method includes binding metal nanoparticles to analyte in a sample, exposing the sample to a substrate comprising a nanoparticle lattice including immobilized molecules, binding the analyte to the immobilized molecules, irradiating the resulting nanoparticle lattice with an excitation source; and detecting or identifying the analyte by measuring the intensity of a plasmon resonance wavelength, λ in nm.

### BRIEF DESCRIPTION OF THE DRAWINGS

FIG. 1 is a perspective view of an array with a plurality of regions or spots.

FIG. 1A is an enlargement of a region from FIG. 1, the region containing a nanoparticle lattice.

FIG. 2 is a sectional view of an embodiment of a nanoparticle lattice.

FIG. 3 is a sectional view of an embodiment of a substrate including two nanoparticle lattices.

FIG. 4 is an AFM (atomic force microscope) height image of a self-assembled PS-PFS film (25% PFS) (1 micron by 1 micron scale, 10 nm full scale).

### DETAILED DESCRIPTION

Various embodiments of the present invention will be described in detail with reference to the drawings, wherein like reference numerals represent like parts throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

An “array”, unless a contrary intention appears, includes any one-, two- or three-dimensional arrangement of addressable regions bearing a particular chemical moiety or moieties (for example, biomolecules such as antibodies) associated with that region. An array is “addressable” in that it has multiple regions of different moieties (for example, different antibodies) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces. In the case of an array, the “analyte” will be referenced as a moiety in a mobile phase (typically fluid), to be detected by immobilized molecules which are bound to the substrate at the various regions. However, either of the “analyte” or “immobilized molecules” may be the one which is to be evaluated by the other. Immobilized molecules may be covalently bound to a surface of a non-porous or porous substrate either directly or through a linker molecule, or may be adsorbed to a surface using intermediate layers (such as polylysine) or porous substrates.

An “array layout” refers to one or more characteristics of the array or the features on it. Such characteristics include one or more of: feature positioning on the substrate; one or more feature dimensions; some indication of an identity or function (for example, chemical or biological) of a moiety at a given location; how the array should be handled (for example, conditions under which the array is exposed to a sample, or array reading specifications or controls following sample exposure).

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing the invention components that are described in the publications that might be used in connection with the presently described invention.

General

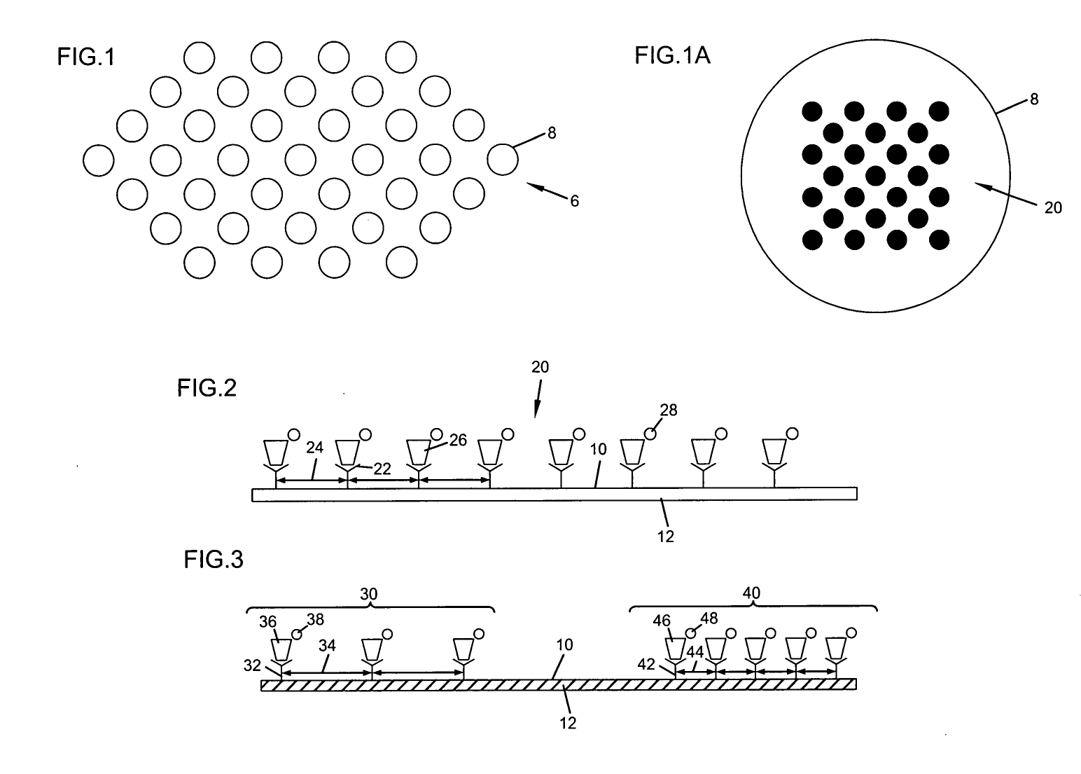

The present invention relates to a system including at least one nanoparticle lattice on a substrate. A nanoparticle lattice is included in a region or spot on an array. An example is illustrated in FIGS. 1 and 1A. In FIG. 1, array 6 includes a plurality of defined regions 8. In FIG. 1A, one region 8 of array 6 is enlarged to show a nanoparticle lattice 20. In a further embodiment, an array of spots has a nanoparticle lattice in each spot. Alternatively, a nanoparticle lattice is associated with other detectable structures or is an isolated structure. A substrate including at least one nanoparticle lattice is suitable for use in point of care testing.

A nanoparticle lattice refers to an ordered pattern of individual nanoparticles. In an embodiment, the substrate including a nanoparticle lattice is suitable for optical measurement of surface plasmon resonance. The shift in extinction intensity or extinction peak upon analyte binding to the nanoparticle lattice provides the basis for detection. The nanoparticle lattice is designed to generate a well-defined optical signature. The well-defined optical signature is either wavelength-resolved or spatially resolved.

Nanoparticle Lattice

“Nanoparticle lattice” refers to an ordered pattern of individual nanoparticles. The ordered pattern of individual nanoparticles are described in one aspect by interparticle spacing. Interparticle spacing refers to the average distance between any two adjacent nanoparticles within the ordered pattern of a nanoparticle lattice. In an embodiment, the interparticle spacing is uniform. Uniform interparticle spacing refers to the spacing between any two adjacent nanoparticles being consistent for a nanoparticle lattice within an allowed margin of error.

In an embodiment, a nanoparticle lattice is a one-dimensional (ID) lattice, i.e. a line. A one-dimensional nanoparticle lattice refers to a linear arrangement of nanoparticles. In a further embodiment, a one-dimensional nanoparticle lattice includes at least about 50 nanoparticles.

In an embodiment, a nanoparticle two-dimensional lattice is a plane including an ordered pattern. The outer boundary of the ordered pattern or nanoparticle lattice may be square, rectangular, circular or other regular or irregular shape.

The ordered pattern within a two-dimensional lattice may be described as an arrangement of a plurality of repeating unit cells. Unit cells may be square, rectangular, parallelogram, triangular, hexagonal, or other shapes and mixtures there of.

In various embodiments, the lattice size (i.e. number of nanoparticles, not limited to square patterns) is from about 10×10 to about 1000×1000. In a further embodiment, the lattice size is from about 5×5 to about 1000×1000. In a still further embodiment, the lattice size is from about 10×10 to about 500×500. In a still further embodiment, the lattice size is from about 10×10 to about 100×100. In a still further embodiment, the lattice size is about 50×50.

In an embodiment, a nanoparticle lattice is less than 1000 μm (microns; 10⁻⁶ m) in breadth (e.g., length or width). In an embodiment, the dimensions of a lattice are determined by the number of nanoparticles, the interparticle spacing, and nature of ordered pattern. In an embodiment, the surface dimensions of an individual lattice are from about 5 μm to about 500 μm. In a further embodiment, the surface dimensions of an individual lattice are from about 10 μm to about 100 μm.

Interparticle Spacing

The spectra of a nanoparticle lattice is influenced by nanoparticle material, nanoparticle size and shape, the interactions between the nanoparticles (e.g., separation distance), and the polarization of the incident light. In an embodiment, the nanoparticle lattice is designed to enhance the cross-section of light extinction for use in optical measurement of extinction intensity (e.g. I/Iₒ). I is reduced either by absorption of incident light or by scattering in a direction away from the incident direction. A nanoparticle lattice may be used in optical measurement of absorbed and/or scattered light. In an embodiment, a nanoparticle lattice is for use in optical measurement of surface plasmon resonance. A shift in plasmon wavelength upon analyte binding to the nanoparticle lattice provides the basis for detection. In a further embodiment, a shift in plasmon wavelength upon analyte binding to the nanoparticle lattice provides a shift in visible color of the lattice.

In an embodiment, a nanoparticle lattice has a desired interparticle spacing for enhancement of optical measurement. In an embodiment, the desired interparticle spacing is selected to enhance the extinction of light and/or to generate a well-defined optical signature. The well-defined optical signature may be either wavelength-resolved or spatially resolved.

In an embodiment, the interparticle spacing is selected to “tune” improve by increasing intensity and/or narrowing the linewidth of plasmon resonance at a selected wavelength (or narrow band of wavelengths). In a further embodiment, a desired interparticle spacing is selected to improve the plasmon resonance at longer wavelengths. In a further embodiment, the detection is improved by selecting a plasmon resonance at a longer wavelength where the optical detector is more sensitive. In an embodiment, an optical detector is a Silicon photodiode. For example, Silicon photodiodes have better spectral responsiveness from about 700 nm to about 1000 nm than outside of that range, e.g., 450 nm.

In an embodiment, the interparticle spacing in a lattice is in the range from about 100 nm to 1000 nm. In a further embodiment, the interparticle spacing is between about 500 nm to about 1000 nm. In a still further embodiment, the interparticle spacing is between about 700 nm to about 900 nm.

In an embodiment, the interparticle spacing in a lattice is in the range from about from about 0.5 times to about 3.5 times the particle diameter. In an further embodiment, the interparticle spacing in a lattice is in the range from about from about 0.5 times to about 10 times the particle diameter. In an embodiment, the interparticle spacing is related to the plasmon resonance peaks in the extinction spectra of the nanoparticle lattice. In an embodiment, the interparticle spacing is approximately twice the particle diameter.

Substrate Surface

A nanoparticle lattice is supported by a substrate. Suitable substrates are any solid object having a surface suitable for supporting a patterned region. Substrates include, but are not limited to: strips, dipsticks, slides, wafers, paper, cups, cells, wells, and plates. As used herein a “area” of a substrate or surface thereof refers to a contiguous area of the support or surface thereof containing a nanoparticle lattice.

In another embodiment, each nanoparticle lattice is formed on a tile. The tiles are small supports, generally less than 1000 μm, sized to hold one or more nanoparticle lattices. In a further embodiment, each tile holds one nanoparticle lattice. In another embodiment, a tile holds two or more nanoparticle lattices on one or both faces of the tile. Size of a tile refers generally to the dimensions (i.e. length and width) of a surface for holding a nanoparticle lattice. In an embodiment, the surface dimensions of an individual tile are from about 5 μm to about 500 μm. In a further embodiment, the surface dimensions of an individual tile are from about 10 μm to about 100 μm. The tiles are operatively connected to a larger substrate either individually or in bulk. A plurality of tiles, wherein each tile carries a nanoparticle lattice, may be applied in a suspension or paste to a substrate.

In an embodiment, a substrate includes two or more nanoparticle lattices, wherein the lattices have uniform interparticle spacing. In a further embodiment, wherein a substrate includes two or more lattices, the lattices are spatially resolved. In a further embodiment, wherein two or more nanoparticle lattices are spatially resolved the plasmon resonance is individually detected from each nanoparticle lattice.

In an alternative embodiment, a substrate includes two or more nanoparticle lattices, wherein each lattice has a different average interparticle spacing.

In a further embodiment, nanoparticle lattices having different average interparticle spacing are adjacent or in close proximity on a substrate surface. In an embodiment, two or more nanoparticle lattices, a distinct interparticle spacing is selected for nanoparticle lattices that are adjacent or in close proximity so that the absorbance detected from each nanoparticle lattice is spatially resolved.

Assembly of Nanoparticle Lattice

In an embodiment, nanoparticles are operatively connected with a nanoparticle lattice through affinity binding of a nanoparticle to one or a small group of immobilized molecules operatively connected to a patterned region of a substrate.

A patterned region refers to a region of an array or a portion of a substrate patterned with a plurality of sub-spots.

The pattern of sub-spots is referred to as a lattice. In an embodiment, the lattice is an ordered pattern, referring to each sub-spot in the lattice being about equidistant from any adjacent sub-spot in the lattice. The distance from one sub-spot to an adjacent sub-spot is approximately equivalent to interparticle spacing. In an embodiment, a patterned region is patterned with a plurality of sub-spots by techniques including, but not limited to lithography, embossing, or molding.

A cross-sectional view of an embodiment of a nanoparticle lattice is presented in FIG. 2. Nanoparticle lattice 20 is supported on surface 10 of substrate 12. Immobilized molecules 22 are coupled to a sub-spot (not indicated), separated by a distance 24 on surface 10. Immobilized molecules 22 bind to analytes 26, wherein each analyte 26 is labeled with a nanoparticle 28.

In another embodiment, the surface of a substrate includes two or more nanoparticle lattices. An embodiment of a substrate including two or more nanoparticle lattices is illustrated in FIG. 3. FIG. 3 illustrates cross-sections of one embodiment of a substrate 12 including a first nanoparticle lattice 30 and a second nanoparticle lattice 40. Substrate 12 has a surface 10. First nanoparticle lattice 30 includes immobilized molecules 32, coupled to surface 10, and separated by a distance 34. Immobilized molecules 32 bind to analytes 36, wherein each analyte 36 is labeled with a nanoparticle 38. Second nanoparticle lattice 40 includes immobilized molecules 42, coupled to surface 10, and separated by a distance 44. Immobilized molecules 42 bind to analytes 46, wherein each analyte 46 is labeled with a nanoparticle 48.

In an embodiment, the patterned region is chemically modified to form the pattern or lattice of sub-spots. In a further embodiment, the sub-spots have modified surface chemistry for coupling a molecule. The modified surface chemistry includes, but is not limited to modifying the hydrophobicity or charge in each sub-spot. Surface modification to form sub-spots is accomplished by sub-spotting, optical lithography, e-beam lithography, stamping or bottoms-up techniques such as nanosphere lithography, or assembly of block co-polymers.

In an embodiment, a sub-spot is formed on a support is accomplished by methods and apparatus such as pin spotters (sometimes referred to as printers). Pin spotters are capable of sub-spotting more than 100,000 spots on a microscope slide. Other spotters include piezoelectric spotters (similar to ink jets) and electromagnetic spotters.

In an embodiment, a patterned region is formed using diblock copolymers. Diblock copolymers refer to macromolecules comprised of two mutually immiscible polymer chains joined together by a covalent bond. Microphase separation of the chains of the copolymer is driven by the enthalpy of demixing of the two components in a polymer chain with different chemical and physical affinities. Concurrently, macrophase separation is prevented by the covalent bond within each chain. The decrease in Gibbs energy resulting from minimization of interfacial area balances against the resulting increase in Gibbs energy from the more extended chain conformation. The balance results in self-assembly of ordered structures in nanometer scale.

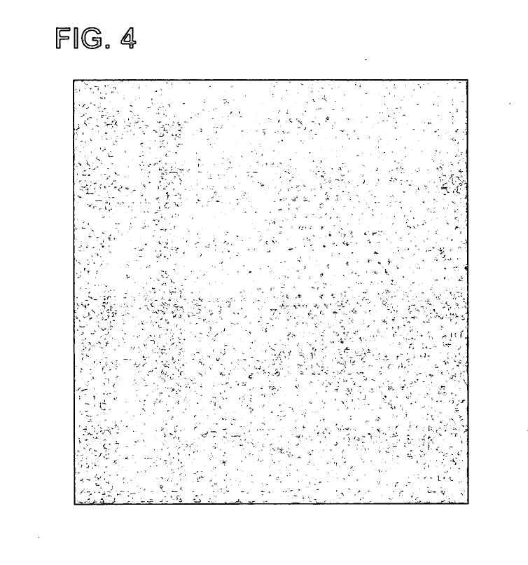

In an embodiment, a patterned region or portion on a substrate is formed using diblock copolymers by depositing a layer of diblock copolymer upon a surface of the support or region thereof. In a further embodiment, the layer of diblock copolymer self-assembles into an ordered morphology. For example, the layer of diblock copolymer self-assembles into close-packed hexagonal morphology. For example, PS-PFS block copolymer with a volume fraction of approximately 25% polyferrocenylsilane forms a close-packed hexagonal structure. An AFM (atomic force microscope) height image of a self-assembled PS-PFS film is shown in FIG. 4.

In an embodiment, one polymer component of the diblock copolymer is susceptible to a removal process, such as but not limited to UV-ozonation and chemical salvation, while the other polymer component of the diblock copolymer is resistant to removal and remains on the substrate surface.

In an embodiment, a patterned region is formed by the following method. A layer of diblock copolymer is deposited on a substrate or region thereof. The diblock copolymer self assembles into an ordered morphology. The ordered morphology comprises domains in a matrix. In a further embodiment, the ordered morphology is close-packed hexagonal. A subtractive process is applied to remove one polymer component of the diblock copolymer. In an embodiment, the matrix surrounding the isolated domains is removed thereby leaving the domains on the surface in a ordered pattern of posts. A second polymer layer is deposited on the surface or region thereof over the posts. The second polymer layer is etched back to reveal the tops of the posts. In an embodiment, the immobilized molecules preferentially bind to the posts rather than the second polymer layer.

In a further embodiment of the above process, the diblock copolymer deposited on the substrate or region thereof is polystyrene-b-polyferrocenylsilane (PS-PFS). In a further embodiment, a representative chemical structure of the PS-PFS diblock copolymer is illustrated below.

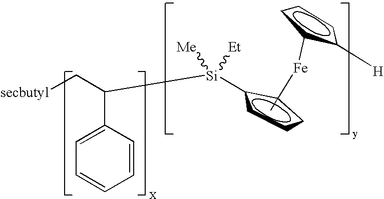

In a further embodiment, the diblock copolymer is PS-PFS wherein PFS domains are embedded in a PS matrix. In a further embodiment, the PS domains are susceptible to removal by UV-ozonation.

In a further embodiment of the above process, the PS component (e.g., matrix) of the deposited diblock copolymer is removed by UV-ozonation, leaving a ordered pattern of SiO₂/Fe₂O₃ posts on the substrate or region thereof. A second polymer layer is deposited over the posts and etched back to reveal the top surfaces of the SiO₂/Fe₂O₃ posts. In a further embodiment, the immobilized molecules selectively bind to the SiO₂/Fe₂O₃ posts rather than the surrounding second polymer layer. For example, the surrounding second polymer layer is a fluorinated polymer and the immobilized molecules are biomolecules that selectively bind to the SiO₂/Fe₂O₃ posts.

In an embodiment, a patterned region is formed by the following method. The substrate or region thereof is formed of silicon oxide or has a silicon oxide surface, provided for example by a layer or coating. In the next step of the method, a layer of diblock copolymer is deposited on the silicon oxide surface. In an embodiment, the diblock copolymer forms a close-packed hexagonal morphology on the silicon oxide surface. In an embodiment, the diblock copolymer comprises a first component (e.g., matrix) that is a hydrophobic polymer or a polymer that is treated to present a non-reactive (e.g., non-sticky) surface for biomolecules and a second polymer component (e.g., domains) that is removed by chemical treatment to expose a ordered pattern of openings, wherein each opening exposes the silicon oxide layer. In a further embodiment, suitable diblock copolymers are polystyrene-b-polyferrocenylsilane (PS-PFS) or polystyrene-b-polymethylmethacrylate (PS-b-PMMA).

Next, a subtractive process is applied to remove one polymer component of the diblock copolymer (e.g., the domains), thereby resulting in a nanoporous film. The nanoporous film defines a ordered pattern of silicon oxide sub-spots for binding immobilized molecules. In a further embodiment, the matrix of the nanoporous film is converted to carbon by H₂ plasma to discourage binding of immobilized molecules to the matrix. The immobilized molecules selectively bind to the silicon oxide surfaces defined by the pores of the nanoporous film.

One example of a diblock polymer film suitable for use in the above methods is shown in FIG. 4. FIG. 4 is an AFM (atomic force microscope) height image of a self-assembled PS*PFS film (75% PS/25% PFS) (1 micron by 1 micron scale, 10 nm full scale). The film shown is a polystyrene film with domains formed by PFS. The PFS was subsequently removed, leaving the voids apparent in FIG. 4.

Surface-Bound Molecules

Making a patterned region includes forming a region including a plurality of sub-spots on an array, substrate or tile, and operatively coupling one or more immobilized molecules to the sub-spots. As used herein, the term “immobilized” or “surface-bound” are used interchangeably with respect to molecules coupled to a nanoparticle lattice, and refers to molecules being stably oriented on the sub-spots of the patterned region, so that they do not migrate. In an embodiment, surface-bound molecules are coupled by covalent coupling, ionic interactions, electrostatic interactions, or van der Waals forces. The immobilized molecules can be operatively coupled to the sub-spots by mixing a plurality of activated molecules and employing the mixture in forming the region or regions. Alternatively, the molecules can be applied individually to the sub-spots.

In an embodiment, immobilized molecules are arranged into an ordered pattern by operatively coupling to a patterned region. In an embodiment, a single immobilized molecule is coupled onto each sub-spot of a patterned region thereof. In an alternative embodiment, a small group of immobilized molecules are operatively connected at each sub-spot. In both embodiments, one nanoparticle is operatively connected with the one or the small group of immobilized molecules at each sub-spot.

In an embodiment, the patterned region is modified to form sticky sub-spots for operatively connecting one or more immobilized molecules. Additionally, the surface of the support may be treated to not bind immobilized molecules, thereby improving selective binding of one or a small group of immobilized molecules to each sub-spot. In an embodiment, a sub-spot has limited size for preferably coupling a single immobilized molecule. In another embodiment, a sub-spot is a limited area such that one or a small group of immobilized molecules are operatively connected to one nanoparticle. For example, a sub-spot and associated immobilized molecules operatively connected to a nanoparticle or nanoparticle-labeled analyte are covered such that additional nanoparticles or nanoparticle-labeled analytes are blocked from binding to that sub-spot.

In an embodiment, the sub-spots have modified surface chemistry for coupling a molecule. In an embodiment, the modified surface chemistry includes, but is not limited to modifying the hydrophobicity or charge in each sub-spot. In an embodiment, surface modification to form sub-spots is accomplished by optical lithography, e-beam lithography, stamping or bottoms-up techniques such as nanosphere lithography, or assembly of block co-polymers.

In an embodiment, a molecule is activated to react with a function group on the sub-spot. Coupling can occur spontaneously after forming the sub-spot of the molecule or activated molecule. In an embodiment, the method includes sub-spotting individual activated molecules on the support.

In an embodiment, a molecule is coupled to a sub-spot on a support by methods and apparatus such as pin sub-spotters (sometimes referred to as printers), which can, for example, sub-spot 10,000 to more than 100,000 sub-spots on a microscope slide. Other sub-spotters include piezoelectric sub-spotters (similar to ink jets) and electromagnetic sub-spotters that can also sub-spot, for example, 10,000 to more than 100,000 sub-spots on a microscope slide. Conventional mixing valves or manifolds can be employed to mix the activated molecules before sub-spotting. These valves or manifolds can be under control of conventional microprocessor based controllers for selecting molecules and amounts of reagents. Such sub-spotting yields a lattice of sub-spots each having an immobilized molecule. In an embodiment, sub-spots are formed according to methods and apparatus of U.S. patent Publication No. 2005/0100480, assigned to Agilent Technologies, Inc.

A substrate surface or region thereof is printed with a pattern of sub-spots, wherein each sub-spot contains a reactive moiety for coupling an immobilized molecule. The substrate surface or region is subsequently exposed to a plurality of “immobilized molecules” under conditions such that the reactive moieties in each sub-spot couple to an immobilized molecule. Uncoupled molecules are washed from the substrate. The immobilized molecules coupled to the reactive moieties in the sub-spots remain on the substrate forming a lattice.

In an embodiment, immobilized molecules are coupled to sub-spots using known methods for activating compounds of the types employed as immobilized molecules and for coupling them to supports. In an embodiment, the immobilized molecules include activated esters and are coupled to sub-spots including amine functional groups. In an embodiment, the immobilized molecules each include an amine functional group that can couple to sub-spots including carboxyl groups. Pairs of functional groups that can be employed on immobilized molecules and sub-spots (supports) include, but are not limited to: nucleophile/electrophile pairs, such as amine and carboxyl (or activated carboxyl), thiol and maleimide, alcohol and carboxyl (or activated carboxyl), mixtures thereof, and the like.

In an embodiment, a sub-spot can include any functional group suitable for forming a covalent bond with an immobilized molecule. In an embodiment, either the immobilized molecule or sub-spot includes a functional group such as alcohol, phenol, thiol, amine, carbonyl, or like group. In an embodiment, the immobilized molecule or sub-spot includes a carboxyl, alcohol, phenol, thiol, amine, carbonyl, maleimide, or like group that can react with or be activated to react with the sub-spot or the immobilized molecule. In an embodiment, either the immobilized molecule or sub-spot includes one or more of these groups.

In an embodiment, either the immobilized molecule or sub-spot includes a good leaving group bonded to, for example, an alkyl or aryl group. The leaving group being “good” enough to be displaced by the alcohol, phenol, thiol, amine, carbonyl, or like group on the immobilized molecule or sub-spot. Such a sub-spot or the immobilized molecule can include a moiety represented by the formula: R—X, in which X is a leaving group such as halogen (e.g., —Cl, —Br, or —I), tosylate, mesylate, triflate, and R is alkyl, substituted alkyl, cycloalkyl, heterocyclic, substituted heterocyclic, aryl alkyl, aryl, heteroaryl, or heteroaryl alkyl. The support can include one or more of these groups. A plurality of immobilized molecules can include a plurality of these groups.

In an embodiment, the sub-spots on the support for binding an immobilized molecule are surrounded by material that is non-reactive to the immobilized molecules. In an embodiment, the sub-spots for binding an immobilized molecule are considered “sticky” (e.g., reactive) to immobilized molecules, while the material surrounding the sub-spots is “non-sticky” (e.g., unreactive). In an embodiment, the immobilized molecules selectively bind to sticky sub-spots, for example, but not limited to SiO₂ or SiO₂/Fe₂O₃ sub-spots. In an embodiment, the sticky sub-spots are defined by pores in a nanoporous layer. In an embodiment, the material forming the nanoporous layer is non-sticky. In a further embodiment, the material forming the nanoporous layer is surface treated to be unreactive with the immobilized molecules. In an embodiment, the sub-spots are top surfaces of posts, wherein the posts are surrounded by material unreactive to the immobilized molecules. In a still further embodiment, the size of each post or the size of each pore in the nanoporous layer is selected to bind a single immobilized molecule.

Immobilized Molecule and Analyte molecule Binding Pairs

In an embodiment, an immobilized molecule and an analyte molecule form a binding pair. A binding pair refers to an immobilized molecule and an analyte that binds to each other with sufficient specificity and affinity for detection of the interaction, as described below. In an embodiment, a nanoparticle lattice includes a plurality of binding pairs. In a further embodiment, a nanoparticle lattice includes a plurality of immobilized molecules of one chemical identity. In an embodiment having a substrate including two or more nanoparticle lattices, each nanoparticle lattice includes immobilized molecules having the same identity. In other embodiments, where a substrate includes two or more nanoparticle lattices, each nanoparticle lattice includes immobilized molecules with different identity between the lattices.

The immobilized molecule and analyte are any binding pair including, but not limited to, antibody/antigen, antibody/antibody, antibody/antibody fragment, antibody/antibody receptor, antibody/protein A or protein G, hapten/anti-hapten, biotin/avidin, biotin/streptavidin, folic acid/folate binding protein, vitamin B12/intrinsic factor, nucleic acid/complementary nucleic acid (e.g., DNA, RNA, PNA), and chemical reactive group/complementary chemical reactive group (e.g., sulfhydryl/maleimide, sulfhydryl/haloacetyl derivative, amine/isotriocyanate, amine/succinimidyl ester, and amine/sulfonyl halides).

In certain embodiments, the immobilized molecule is a biological binding partner of the analyte. For example, where the analyte is a subregion of a receptor protein kinase such as EGF receptor, the binding partner is EGF or a functional fragment thereof; where the analyte is a nucleic acid, the binding partner sometimes is a transcription factor or histone or a functional portion thereof; or where the analyte is a glycosyl moiety, the binding partner sometimes is a glycosyl binding protein or a portion thereof.

In an embodiment, the analyte molecule is the substance to be detected which may be present in the test sample. In a further embodiment, the immobilized molecule is selected for its ability to bind the analyte molecule.

The analyte can include a protein, a peptide, an amino acid, a hormone, a steroid, a vitamin, a drug including those administered for therapeutic purposes as well as those administered for illicit purposes, a bacterium, a virus, and metabolites of or antibodies to any of the above substances. In particular, such analytes include, but are not intended to be limited to, ferritin; creatinine kinase MB (CK-MB); digoxin; phenyloin; phenobarbital; carbamazepine; vancomycin; gentamicin, theophylline; valproic acid; quinidine; luteinizing hormone (LH); follicle stimulating hormone (FSH); estradiol, progesterone; IgE antibodies; vitamin B2 micro-globulin; glycated hemoglobin (Gly Hb); cortisol; digitoxin; N-acetylprocainamide (NAPA); procainamide; antibodies to rubella, such as rubella-IgG and rubella-IgM; antibodies to toxoplasma, such as toxoplasmosis IgG (Toxo-IgG) and toxoplasmosis IgM (Toxo-IgM); testosterone; salicylates; acetaminophen; hepatitis B core antigen, such as anti-hepatitis B core antigen IgG and IgM (Anti-HBC); human immune deficiency virus 1 and 2 (HIV 1 and 2); human T-cell leukemia virus 1 and 2 (HTLV); hepatitis B antigen (HBAg); antibodies to hepatitis B antigen (Anti-HB); thyroid stimulating hormone (TSH); thyroxine (T4); total triiodothyronine (Total T3); free triiodothyronine (Free T3); carcinoembryonic antigen (CEA); and alpha fetal protein (AFP). Drugs of abuse and controlled substances include, but are not intended to be limited to, amphetamine; methamphetamine; barbiturates such as amobarbital, secobarbital, pentobarbital, phenobarbital, and barbital; benzodiazepines such as librium and valium; cannabinoids such as hashish and marijuana; cocaine; fentanyl; LSD; methaqualone; opiates such as heroin, morphine, codeine, hydromorphone, hydrocodone, methadone, oxycodone, oxymorphone, and opium; phencyclidine; and propoxyphene. The details for the preparation of such antibodies and their suitability for use as specific binding members are well known to those skilled in the art.

Nanoparticles

Nanoparticles for a nanoparticle lattice are operatively coupled to a patterned region. In an embodiment, nanoparticles are individually coupled to a patterned region by interaction with a binding pair. In a further embodiment, nanoparticles are individually coupled to a patterned region by interaction with an immobilized molecule. In a further embodiment, nanoparticles are individually coupled to a patterned region by interaction with an analyte molecule that binds to an immobilized molecule. In a still further embodiment, a single nanoparticle is coupled to each sub-spot on a substrate by interaction with an analyte molecule bound to an immobilized molecule.

In an embodiment, nanoparticles refer to solid metal particles of nanoscale size. In an embodiment, nanoparticles are solid metal particles of a metal for which surface plasmons are excited by visible radiation. In a further embodiment, nanoparticles are solid metal particles of copper (Cu), silver (Ag), or gold (Au).

In an embodiment, nanoparticles refer to nanoscale size cores (e.g., nanospheres) coated with metal layers (e.g., metal nanoshells). In an embodiment, the core diameter and the metal thickness of nanoshells can be varied to modify the LSPR properties of the nanoparticles. See, for example, R. L. Moody, T. Vo-Dinh, and W. H. Fletcher, “Investigation of Experimental Parameters for Surface-Enhanced Raman Spectroscopy,” Appl. Spectrosc., 41, 966 (1987), and J. B. Jackson and N. J. Halas, “Silver nanoshells: Variations in morphologies and optical properties,” J. Phys. Chem. B 105, 2743 (2001).

In an embodiment, nanospheres are formed of dielectric materials. In an embodiment, nanospheres are coated with a thin layer of metal for which surface plasmons are excited by visible radiation. In a further embodiment, the nanoshells are formed from metal of copper (Cu), silver (Ag), or gold (Au).

In an embodiment, nanoparticles have an average diameter from about 1 nm to about 1000 nm. In a still further embodiment, nanoparticles have an average diameter from about 10 nm to about 500 nm. In a yet another embodiment, nanoparticles have an average diameter from about 10 nm to about 100 nm. In a final embodiment, nanoparticles have an average diameter from about 10 nm to about 50 nm.

In an embodiment, nanoparticles are bound to the analyte to be detected. In an embodiment, a nanoparticle bound to an analyte is referred to as a tag nanoparticle. In an embodiment, tag nanoparticles are bound to many ligands (e.g., sample components), including the analyte (if present) in a sample.

Nanoparticles are bound to analyte and other ligands in a sample by known techniques. In an embodiment, the surfaces of the tag nanoparticles are functionalized for binding to analyte functional groups. In an embodiment, tag nanoparticles are functionalized with thiol derivatives. In an embodiment, gold tag nanoparticles bind to thiol-functionalized analytes. In an embodiment, tag nanoparticles are bound to analyte by cross-linking chemistry. In an embodiment, cross-linking agents are selected based on reactivity with the tag nanoparticle and analyte.

In a further embodiment, an EDC (1-ethyl-3-(3-dimethylamino propyl) carbodiimide hydrochloride)/sulfo-NHS(N-hydroxy-sulfosuccinimide) cross-linking procedure is used. For example, a sample is mixed with freshly prepared solutions of 0.2M EDC and 25 mM NHS, followed by addition of nanoparticles. In an alternative example, gold nanoparticles are prepared by mixing with HS(CH₂)₂CH₃ and HS(CH₂)₂COOH for 24 hours with stirring and subsequently reacting with ECD and NHS for 30 minutes. This preparation is subsequently added to a sample or analyte to be labeled.

In an embodiment, a method of forming a substrate containing a nanoparticle lattice is as follows. A substrate surface or region thereof is provided with a pattern of sub-spots, wherein each sub-spot contains a reactive moiety for coupling an immobilized molecule. The substrate surface or region is subsequently exposed to a plurality of “immobilized molecules” under conditions such that the reactive moieties in each sub-spot couple to an immobilized molecule. Uncoupled molecules are washed from the substrate. The immobilized molecules coupled to the reactive moieties in the sub-spots remain on the substrate forming a lattice. The lattice is exposed to a sample containing nanoparticle-labeled analytes under conditions to allow binding. Nanoparticle-labeled analytes bound to the lattice have detectable plasmon resonance.

Assays

Substantially all types of assays can be carried out with a substrate including at least one nanoparticle lattice for a wide variety of analytes. Assays that can be performed include, but are not limited to, general chemistry assays and immunoassays. Both endpoint and reaction rate type assays can be accomplished with the present invention.

In an embodiment, a single assay is performed. A substrate for performing a single assay includes a single nanoparticle lattice or may include multiple nanoparticle lattices.

In an embodiment multiple assays can be done at one time. In a further embodiment, a substrate includes multiple nanoparticle lattices. In a still further embodiment, a substrate includes multiple nanoparticle lattices that are non-identical. Non-identical nanoparticle lattice refers to differences between two or more lattices, including but not limited to: nanoparticle material, particle size or shape, interparticle spacing, and identity of immobilized molecule. For example, in an embodiment, a substrate includes a lattice for detecting total cholesterol and another lattice for detecting HDL cholesterol from a single sample. In various embodiments, a substrate includes various numbers of nanoparticle lattices to analyze to measure one, two, three, or more analytes at one time.

Method of Using Substrates Containing One or More Nanoparticle Lattices.

One typical assay method involves a substrate including at least one nanoparticle lattice, wherein at least one nanoparticle lattice includes one or a small group of immobilized molecules at each sub-spot of the lattice, wherein the immobilized molecule has binding affinity for a target molecule. The target molecules (“analytes”) are each associated with a metal tag nanoparticle. A solution containing the analytes is placed in contact with the substrate in the region including the nanoparticle lattice under conditions sufficient to promote binding of target molecules in the solution to the lattice. Binding of the target molecule to the immobilized molecules forms a binding complex that is bound to the surface of the substrate and includes a single nanoparticle. The binding by a target molecule to immobilized molecules at each sub-spot of the lattice produces a pattern of nanoparticles, on the surface of the substrate, which pattern is then detected. This detection of binding complexes provides desired information about the target biomolecules in the solution.

The nanoparticle lattice is detected by reading or scanning the lattice by optical means. In an embodiment, the nanoparticle lattice is excited by a source, including but not limited to broad band sources, such as sunlight, ambient room lighting, and light bulbs, and narrow band sources, such as lasers. In an embodiment, source excitation of the nanoparticle lattice causes plasmon resonance detected by a suitable detector. Plasmon resonance generates a signal only in those sub-spots on the lattice that have a nanoparticle-associated analyte bound to an immobilized molecule. In an embodiment, the pattern of nanoparticles is digitally scanned for computer analysis.

In various embodiments, such patterns can be used to generate data for chemical analysis. In further various embodiments, data is used for, but not limited to: the identification of drug targets, single-nucleotide polymorphism mapping, monitoring samples from patients to track their response to treatment, and assessing the efficacy of new treatments.

The sample to be tested for the presence of an analyte can be derived from any biological source, such as a physiological fluid, including whole blood or whole blood components including red blood cells, white blood cells, platelets, serum and plasma; ascites; urine; sweat; milk; synovial fluid; peritoneal fluid; amniotic fluid; cerebrospinal fluid; and other constituents of the body which may contain the analyte of interest. The test sample can be pre-treated prior to use, such as preparing plasma from blood, diluting viscous fluids, or the like; methods of treatment can involve filtration, distillation, concentration, and the addition of reagents. Besides physiological fluids, other liquid samples can be used such as water, food products and the like for the performance of environmental or food production assays. In addition, a solid material suspected of containing the analyte can be used as the test sample. In some instances it may be beneficial to modify a solid test sample to form a liquid medium or to release the analyte. The analyte can be any compound or composition to be detected or measured and which has at least one epitope or binding site.

POCT

Point-of-care testing (POCT) is laboratory testing that is performed at the site of the patient. POCT allows providers to perform tests quickly and accurately in order to optimize patient management. POCT testing is common the medical field, but has broad applicability for diverse types of analysis. Some examples of current medical-related POCT testing includes, but is not limited to: whole blood glucose, whole blood hemoglobin, urine pregnancy, stool for occult blood, urine with dipsticks, rapid strep tests, activated clotting time and ISTAT tests for blood gases, electrolytes, hematocrit, glucose, as well as drug screening for alcohol, and to screen for the presence of defined drugs of abuse. Other example applications include, but are not limited to environmental testing, such as air quality and water quality, security testing for detection of biohazard, toxic, or explosive materials, and biological screening of genetic material (e.g., DNA, RNA), proteins, and pathogens (e.g. HIV).

In an embodiment, POCT devices rely on nanoparticle lattices for use in assays between surface-bound binding molecules (e.g., immobilized molecules) and analyte molecules in solution to detect the presence of particular analytes (e.g., target molecules) in the solution. The surface-bound molecules are molecules capable of binding with target molecules in the solution. In an embodiment, metal nanoparticles are employed to label target molecules that are bound to immobilized molecules for detection by optical readers. In an embodiment, gold (Au) nanoparticles are one example of a label. In an embodiment, the eye of an optical reader detects the light scattered by metal nanoparticles by their surface plasmon resonance.

In an embodiment, a substrate for use in a POCT device includes two or more nanoparticle lattices. In an embodiment, at least one lattice includes immobilized molecules with non-specific binding properties. Non-specific binding refers to molecules that bind to analyte and additional compounds and components present in a sample. In an embodiment, a nanoparticle lattice includes immobilized molecules with non-specific binding properties for use as a positive control. In an embodiment, a positive control has a 100% response upon measurement. In an embodiment, a positive control is used as a reference channel for measurement of analyte binding in other lattices.

In various embodiments, POCT devices, including substrates having one or more nanoparticle lattices, are available in a wide range of packaging formats ranging from strips, dipsticks, cup devices, cards or plastic cassettes. Sample volume also varies and typically ranges from a few drops to ˜30 mL. One common type of testing is immunoassay based for detection of specific molecules. POCT devices may be single use (e.g., disposable), multiple use (e.g., reusable), or a combination of disposable, renewable, refillable, and reusable components.

All publications and patent applications in this specification are indicative of the level of ordinary skill in the art to which this invention pertains and are incorporated herein by reference in their entireties.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention without following the example embodiments and applications illustrated and described herein, and without departing from the true spirit and scope of the present invention, which is set forth in the following claims.

The claimed invention is:

1. A system comprising a nanoparticle lattice on a substrate;
the substrate comprising an ordered pattern;
the nanoparticle lattice comprising:
a plurality of immobilized molecules coupled to the ordered pattern;
at least one analyte bound to at least one immobilized molecule; and
a metal nanoparticle associated with the bound analyte;
the nanoparticles being uniformly spaced; the uniform spacing being at a distance of about 0.5 times to about 10 times the nanoparticle diameter.

2. The system of claim 1, wherein the uniform spacing is about 0.5 times to about 3.5 times the nanoparticle diameter.

3. The system of claim 1, wherein the uniform spacing is about two times the nanoparticle diameter.

4. The system of claim 1, wherein the ordered pattern defines a line.

5. The system of claim 1, wherein the ordered pattern defines a plane.

6. The system of claim 1, wherein the ordered pattern is defined by self-assembly of block copolymers.

7. The system of claim 1, comprising at least about 50 immobilized molecules coupled to the ordered pattern.

8. The system of claim 1, wherein the uniform spacing is about 50 nm to about 100 nm.

9. A kit comprising:
a substrate comprising at least one lattice, the lattice comprising a plurality of first molecules immobilized in an ordered pattern on the substrate, wherein the first molecules are configured to form a binding pair with an analyte when contacted with a sample, and wherein spacing of the ordered pattern is about 10 nm to about 100 nm; and
metal nanoparticles, wherein the metal nanoparticles are configured to operatively couple to an immobilized first molecule.

10. The kit of claim 9, wherein the distance in a range from about 50 nm to about 100 nm.

11. The kit of claim 9, wherein the first molecule comprises an antibody, the antibody recognizing the analyte.

12. The kit of claim 9, wherein the ordered pattern is linear.

13. The kit of claim 9, wherein the ordered pattern is planar.

14. The kit of claim 9, wherein the ordered pattern includes at least 50 immobilized molecules.

15. The kit of claim 9, wherein the substrate includes at least one additional nanoparticle lattice, wherein the additional lattice comprises:
metal nanoparticles, wherein a metal nanoparticle associates the sample when contacted with the sample; and
a plurality of second molecules immobilized in a second ordered pattern on the substrate, wherein the second molecules bind non-specifically to the sample;
wherein the additional lattice serves as a positive control.

16. The kit of claim 15, wherein the second molecules are non-specific antibodies.

17. The kit of claim 9, wherein the sample is a physiological fluid.

18. A method of detecting or identifying an analyte in a sample comprising:
labeling the analyte with metal nanoparticles;
exposing the sample to a substrate comprising a nanoparticle lattice, the lattice comprising:
a plurality of immobilized molecules coupled in a ordered pattern to the substrate, wherein the immobilized molecules have binding affinity for the analyte;
binding the nanoparticle-labeled analyte to the immobilized molecules;
the nanoparticles being uniformly spaced; the uniform spacing being at a distance of about 0.5 times to about 10 times the nanoparticle diameter;
irradiating the nanoparticle lattice with an excitation source; and
detecting or identifying the analyte by measuring the surface plasmon resonance.

19. The method of claim 18, wherein the distance is in a range from about 10 nm to about 100 nm.

20. The method of claim 18, wherein the nanoparticle lattice and ordered pattern are one-dimensional.

21. The method of claim 18, wherein the nanoparticle lattice and ordered pattern are two-dimensional.

22. The method of claim 18, wherein the ordered pattern includes at least about 50 immobilized molecules.

23. A method of forming a nanoscale lattice having uniform spacing, the method comprising:
applying a diblock copolymer to a substrate, wherein the diblock copolymer comprises two immiscible phases and self-assembles into an organized pattern of domains in a matrix; and
selectively removing the domains thereby forming pores, wherein each pore provides a reactive site; and
associating an immobilized molecule with each reactive site, thereby forming a nanoscale lattice.

24. A method of forming a nanoscale lattice having uniform spacing, the method comprising
applying a diblock copolymer to a substrate, wherein the diblock copolymer comprises two immiscible phases and self-assembles into an organized pattern of domains in a matrix; and
selectively removing the matrix thereby exposing an organized pattern of posts, wherein each post provides a reactive site; and
associating an immobilized molecule with each reactive site, thereby forming a nanoscale lattice.
